(19) United States
(12) Patent Application Publication
(10) Pub. No.: US 2019/0283711 A1
(43) Pub. Date: Sep. 19, 2019

(54) Detection and Warning Assembly

(71) Applicant: Daniel Moran, Parachute, CO (US)

(72) Inventor: Daniel Moran, Parachute, CO (US)

(21) Appl. No.: 15/923,144

(22) Filed: Mar. 16, 2018

(51) Int. Cl. B60R 25/31; B60R 25/30

(52) U.S. Cl. CPC B60R 25/31; B60R 25/305

(57) ABSTRACT

A detection and warning assembly for preventing sneak attacks includes a housing. A power module and a microprocessor are coupled to and positioned in the housing. The microprocessor is operationally coupled to the power module. A speaker, a camera, a light, and a sensor are coupled to the housing and are operationally coupled to the microprocessor. Each of a plurality of the housings is configured to couple to an exterior surface the vehicle such that a respective blind spot of the vehicle is covered by the sensor. The sensor is configured to detect a movement in the blind spot and to communicate the movement to the microprocessor. The microprocessor is positioned to selectively activate the speaker to emit a warning sound, the camera to capture an image, and the light to illuminate the blind spot. An occupant of the vehicle is protected from surprise by a person approaching the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to warning assemblies and more particularly pertains to a new warning assembly for preventing sneak attacks.

### BRIEF SUMMARY OF THE INVENTION

An embodiment of the disclosure meets the needs presented above by generally comprising a housing. A power module and a microprocessor are coupled to and positioned in the housing. The microprocessor is operationally coupled to the power module. A speaker, a camera, a light, and a sensor are coupled to the housing and are operationally coupled to the microprocessor. Each of a plurality of the housings is configured to couple to an exterior surface the vehicle such that a respective blind spot of the vehicle is covered by the sensor. The sensor is configured to detect a movement in the blind spot and to communicate the movement to the microprocessor. The microprocessor is positioned to selectively activate the speaker to emit a warning sound, the camera to capture an image, and the light to illuminate the blind spot. An occupant of the vehicle is protected from surprise by a person approaching the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a detection and warning assembly according to an embodiment of the disclosure.

FIG. 2 is a bottom view of an embodiment of the disclosure.

FIG. 3 is a front view of an embodiment of the disclosure.

FIG. 4 is a back view of an embodiment of the disclosure.

FIG. 5 is an in-use view of an embodiment of the disclosure.

### DETAILED DESCRIPTION OF THE INVENTION

With reference now to the drawings, and in particular to FIGS. 1 through 5 thereof, a new warning assembly embodying the principles and concepts of an embodiment of the disclosure and generally designated by the reference numeral 10 will be described.

As best illustrated in FIGS. 1 through 5, the detection and warning assembly 10 generally comprises a housing 12 that defines an interior space 14. The housing 12 is configured to couple to an exterior surface of a vehicle, such as a police car. The housing 12 is substantially rectangularly box shaped.

A coupler 16 is coupled to a back 18 of the housing 12. The coupler 16 is configured to couple the housing 12 to the vehicle. The coupler 16 comprises a plurality of holes 20. Each hole 20 is configured to insert a respective article of mounting hardware to couple the housing 12 to the vehicle. The plurality of holes 20 comprises four holes 20 that are positioned singly proximate to each corner 22 of the back 18 of the housing 12, as shown in FIG. 4.

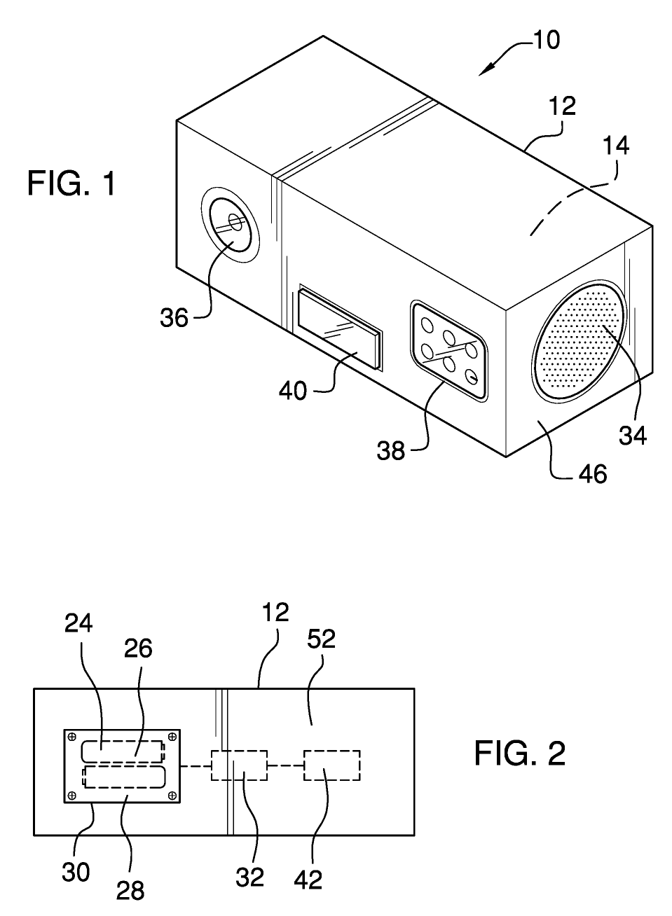

A power module 24 is coupled to the housing 12 and is positioned in the interior space 14. The power module 24 comprises a battery 26. An aperture 28 is positioned in a bottom 52 of the housing 12 adjacent to the power module 24, as shown in FIG. 2. A panel 30 is selectively couplable to the housing 12 to close the aperture 28. The aperture 28 is configured to allow access to the interior space 14 to replace the battery 26.

A microprocessor 32 and a data storage module 42 are coupled to the housing 12 and are positioned in the interior space 14. The microprocessor 32 is operationally coupled to the power module 24. The data storage module 42 is operationally coupled to the microprocessor 32.

A speaker 34, a camera 36, a light 38, and a sensor 40 are coupled to the housing 12 and are operationally coupled to the microprocessor 32. The speaker 34 is configured to emit a warning sound to alert an occupant of the vehicle and to startle a person approaching the vehicle. The light 38 is configured to illuminate an area proximate to the vehicle. The camera 36 is configured to capture an image of the area proximate to the vehicle and the data storage module 42 is positioned to store the image.

The sensor 40 is configured to detect motion. The sensor 40 is passive infrared type or the like. The sensor 40 is configured to detect a movement within the area proximate to the vehicle and to communicate the movement to the microprocessor 32. The microprocessor 32 is positioned to selectively activate the speaker 34, the camera 36, and the light 38.

The light 38 comprises a plurality of light emitting diodes 44. The light emitting diodes 44 are configured to illuminate the area proximate to the vehicle. The light emitting diodes 44 are configured to provide intermittent illumination so that the light emitting diodes 44 are configured to strobe. The plurality of light emitting diodes 44 comprises six light emitting diodes 44, as shown in FIG. 1.

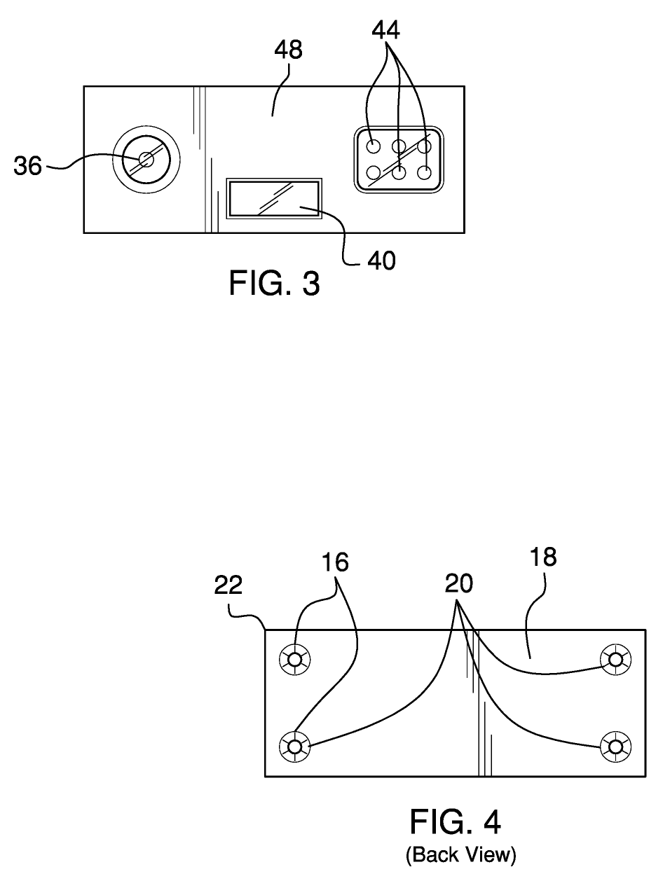

The speaker 34 is positioned on a respective opposing side 46 of the housing 12. The camera 36, the light 38, and the sensor 40 are positioned on a front 48 of the housing 12, as shown in FIG. 3.

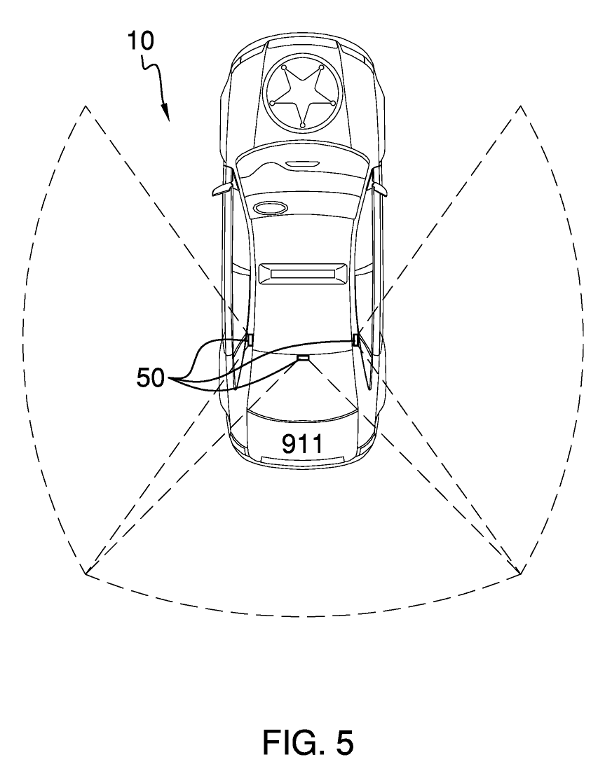

In use, each of a plurality of housings 50 is configured to couple to the vehicle so that a respective blind spot of the vehicle is covered by the sensor 40. As shown in FIG. 5, two housings 12 are coupled singly to opposing sides of the vehicle and another housing 12 is coupled to the rear of the vehicle. The sensor 40 is configured to detect a movement within the area proximate to the vehicle and to communicate the movement to the microprocessor 32. The microprocessor 32 is positioned to selectively activate the speaker 34 to emit the warning sound, the camera 36 to capture the image, and the light 38 to illuminate the blind spot. The occupant of the vehicle is protected from surprise by the person approaching the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A detection and warning assembly comprising:
a housing defining an interior space, said housing being configured for coupling to an exterior surface of a vehicle;
a power module coupled to said housing and positioned in said interior space;
a microprocessor coupled to said housing and positioned in said interior space, said microprocessor being operationally coupled to said power module;
a speaker coupled to said housing, said speaker being operationally coupled to said microprocessor, said speaker being configured for emitting a warning sound for alerting an occupant of the vehicle and for startling a person approaching the vehicle;
a camera coupled to said housing, said camera being operationally coupled to said microprocessor, said camera being configured for capturing an image of an area proximate to the vehicle;
a light coupled to said housing, said light being operationally coupled to said microprocessor, said light being configured for illuminating the area proximate to the vehicle;
a sensor coupled to said housing, said sensor being configured for detecting motion, said sensor being operationally coupled to said microprocessor; and
wherein each of a plurality of said housings is configured for coupling to the vehicle such that a respective blind spot of the vehicle is covered by said sensor, wherein said sensor is positioned on said housing such that said sensor is configured for detecting a movement within the area proximate to the vehicle and for communicating the movement to said microprocessor such that said microprocessor is positioned for selectively activating said speaker, said camera, and said light, such that the occupant of the vehicle is protected from surprise by the person approaching the vehicle.

2. The assembly of claim 1, further including said housing being substantially rectangularly box shaped.

3. The assembly of claim 1, further including a coupler coupled to a back of said housing, said coupler being configured for coupling said housing to the vehicle, wherein said coupler is positioned on said housing such that said coupler is configured for coupling said housing to the vehicle.

4. The assembly of claim 3, further including said coupler comprising a plurality of holes, wherein said holes are positioned in said housing such that each said hole is configured for inserting a respective article of mounting hardware for coupling said housing to the vehicle.

5. The assembly of claim 4, further including said plurality of holes comprising four said holes positioned singly proximate to each corner of said back of said housing.

6. The assembly of claim 1, further including said power module comprising a battery.

7. The assembly of claim 6, further comprising:
an aperture positioned in a bottom of said housing adjacent to said power module;
a panel selectively couplable to said housing for closing said aperture; and
wherein said aperture is positioned in said housing such that said aperture is configured for accessing said interior space for replacing said battery.

8. The assembly of claim 1, further including said speaker being positioned on a respective opposing side of said housing.

9. The assembly of claim 1, further including said camera being positioned on a front of said housing.

10. The assembly of claim 1, further including a data storage module coupled to said housing and positioned in said interior space, said data storage module being operationally coupled to said microprocessor, wherein said data storage module is positioned in said housing such that said data storage module is positioned for storing the image captured by said camera.

11. The assembly of claim 1, further including said light comprising a plurality of light emitting diodes, said light emitting diodes being configured for illuminating the area proximate to the vehicle.

12. The assembly of claim 11, further including said light emitting diodes being configured for intermittent illumination such that said light emitting diodes are configured for strobing.

13. The assembly of claim 11, further including said plurality of light emitting diodes comprising six said light emitting diodes.

14. The assembly of claim 1, further including said light being positioned on a front of said housing.

15. The assembly of claim 1, further including said sensor being passive infrared type.

16. The assembly of claim 1, further including said sensor being positioned on a front of said housing.

17. A detection and warning assembly comprising:
a housing defining an interior space, said housing being configured for coupling to an exterior surface of a vehicle, said housing being substantially rectangularly box shaped;
a coupler coupled to a back of said housing, said coupler being configured for coupling said housing to the vehicle, wherein said coupler is positioned on said housing such that said coupler is configured for coupling said housing to the vehicle, said coupler comprising a plurality of holes, wherein said holes are positioned in said housing such that each said hole is configured for inserting a respective article of mounting hardware for coupling said housing to the vehicle, said plurality of holes comprising four said holes positioned singly proximate to each corner of said back of said housing;
a power module coupled to said housing and positioned in said interior space, said power module comprising a battery;
an aperture positioned in a bottom of said housing adjacent to said power module;
a panel selectively couplable to said housing for closing said aperture, wherein said aperture is positioned in said housing such that said aperture is configured for accessing said interior space for replacing said battery;
a microprocessor coupled to said housing and positioned in said interior space, said microprocessor being operationally coupled to said power module;
a speaker coupled to said housing, said speaker being operationally coupled to said microprocessor, said speaker being configured for emitting a warning sound for alerting an occupant of the vehicle and for startling a person approaching the vehicle, said speaker being positioned on a respective opposing side of said housing;
a camera coupled to said housing, said camera being operationally coupled to said microprocessor, said camera being configured for capturing an image of an area proximate to the vehicle, said camera being positioned on a front of said housing;
a data storage module coupled to said housing and positioned in said interior space, said data storage module being operationally coupled to said microprocessor, wherein said data storage module is positioned in said housing such that said data storage module is positioned for storing the image captured by said camera;
a light coupled to said housing, said light being operationally coupled to said microprocessor, said light being configured for illuminating the area proximate to the vehicle, said light comprising a plurality of light emitting diodes, said light emitting diodes being configured for illuminating the area proximate to the vehicle, said light emitting diodes being configured for intermittent illumination such that said light emitting diodes are configured for strobing, said plurality of light emitting diodes comprising six said light emitting diodes, said light being positioned on said front of said housing;
a sensor coupled to said housing, said sensor being configured for detecting motion, said sensor being operationally coupled to said microprocessor, wherein said sensor is positioned on said housing such that said sensor is configured for detecting a movement within the area proximate to the vehicle and for communicating the movement to said microprocessor such that said microprocessor is positioned for selectively activating said speaker, said camera, and said light, said sensor being passive infrared type, said sensor being positioned on said front of said housing; and
wherein each of a plurality of said housings is configured for coupling to the vehicle such that a respective blind spot of the vehicle is covered by said sensor such that the occupant of the vehicle is protected from surprise by the person approaching the vehicle.
